(19) United States
(12) Patent Application Publication
(10) Pub. No.: US 2009/0046384 A1
(43) Pub. Date: Feb. 19, 2009

(54) Adjustment used for the ground-based observation telescope

(76) Inventor: Chun-Hsien Chiang, Hsin Chuang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/898,809

(22) Filed: Sep. 17, 2007

(30) Foreign Application Priority Data
Aug. 16, 2007 (TW) 096213581

(51) Int. Cl. G02B 7/182

(52) U.S. Cl. 359/871; 359/831

(57) ABSTRACT

An adjustment is provided, which is used for the ground-based observation telescope, comprising a shell body, wherein the adjustment further comprises a base and an adjusting set provided within the shell body, wherein the adjustment further comprises an adjustor provided at the external side surface of the shell body. The base comprises a first mirror and a slide guide, and the adjusting set comprises a second mirror, a guide groove, and a guide tooth space, wherein the guide groove and the slide guide are assembled together, such that the adjusting set can be placed on the base and going to shift correspondingly, wherein the adjustor further comprises an adjusting rotatable button and a driving screw positioned at the same axle, furthermore, the driving screw and the guide tooth space are assembled, such that the guide tooth space can be shifted according to the adjusting rotatable button has been rotated, thus, the second mirror will be shifted corresponding with the first mirror accordingly, wherein the guide tooth space is placed on the back of the guide groove.

### FIELD OF THE INVENTION

The invention relates to an adjustment, and more particularly to an adjustment used for the ground-based observation telescope.

### BACKGROUND OF THE INVENTION

Regarding to the telescope, the focusing adjustment plays a most important role therein, which can be used to observe the object that is at various distances, particularly, for the ground-based observation telescope, that is, the ground-based observation telescope is used to observe the ecological environment at the far sight, such as the birds. During the observation period, the telescope has to be fixed on a steady; thereafter, the observer will take a long time to observe, such that the adjustment has to be demanded more precise accordingly. Certainly, simplifying the adjustment of the telescope and further reducing the volume and weight thereof to achieve the purposes of more precise, more convenient, more stable, and faster adjusting the focus of the telescope will be the effort for most manufactures.

The prior adjustment of the telescope can be used to adjust the focus for having the distinct sight by driving a driving belt to shift the distance between the first prism and the second prism to adjust the focus for having the distinct sight, wherein the driving belt is drove by the adjustor. However, the driving belt will be resulted in elastic deformation due to the overuse thereof, such that the focusing adjustment will be incorrect and further that will be without the focusing function, thus, the life time of the telescope will be limited according to the elastic deformation of the driving belt. On another hand, once the driving belt is going to be replaced with a new one, the telescope may be broken during the disassembly thereof accidentally; otherwise, the accuracy of the telescope may be affected due to the manual carelessness while the telescope is assembled.

Furthermore, the replacement of the driving belt should cost a repairing expense. And, an unstable driving belt may be taken off during the adjusting focus period; besides, the adjustor is placed on the top of the shell body of the telescope, such that is inconvenient for observer.

### SUMMARY OF THE INVENTION

It is a primary object of the present invention to provide an adjustment used for the ground-based observation telescope, wherein the second mirror can be shifted for improving the stability as adjusting focus according to the assembly of the driving screw and the guide tooth space.

It is a secondary object of the present invention to provide an adjustment used for the ground-based observation telescope, wherein the adjustor is placed on the external side of the shell body, such that can be more convenient for observer, and further, the position of the adjustor can be moved according to the observer's dominant hand.

It is another object of the present invention to provide an adjustment used for the ground-based observation telescope, wherein the adjusting rotatable button comprises a coarser adjusting rotatable button and a finer adjusting rotatable button for more convenient.

It is another object of the present invention to provide an adjustment used for the ground-based observation telescope, wherein a socket is provided fixedly on the first mirror, and the second mirror comprises a transpierced hole and a slide bar, wherein the slide bar is fixed on said socket by passing through the transpierced hole for improving the stability while the second mirror is moving.

To achieve the previous mentioned objects, the present invention provides an adjustment used for the ground-based observation telescope, comprising a base comprising a first mirror and a slide guide; an adjusting set comprising a second mirror, a guide groove, and a guide tooth space, wherein the guide groove and the slide guide are assembled together, wherein the guide tooth space and the guide tooth space are provided back to back with each other, wherein the second mirror is positioned corresponding with the first mirror; and an adjustor comprising an adjusting rotatable button and a driving screw, both of which are positioned at the same axle, wherein the driving screw and the guide tooth space are assembled together, wherein the guide tooth space can be shifted since the adjusting rotatable button has been rotated, and the second mirror will be shifted corresponding the first mirror accordingly.

### BRIEF DESCRIPTION OF THE DRAWINGS

It will be understood that the figures are not to scale since the individual layers are too thin and the thickness differences of various layers too great to permit depiction to scale.

FIG. 1 is a three-dimensional diagram of a preferred embodiment of the present invention regarding to an adjustment used for the ground-based observation telescope.

FIG. 2 is a structure decomposing diagram of a preferred embodiment of the present invention.

FIG. 3 is a structure assembly diagram of a preferred embodiment of the present invention.

FIG. 4A is a diagram of a preferred embodiment of the present invention regarding to the action of the adjustment.

FIG. 4B is a diagram of a preferred embodiment of the present invention regarding to the action of the adjustment.

### DETAILED DESCRIPTION OF THE INVENTION

The structural features and the effects to be achieved may further be understood and appreciated by reference to the presently preferred embodiments together with the detailed description.

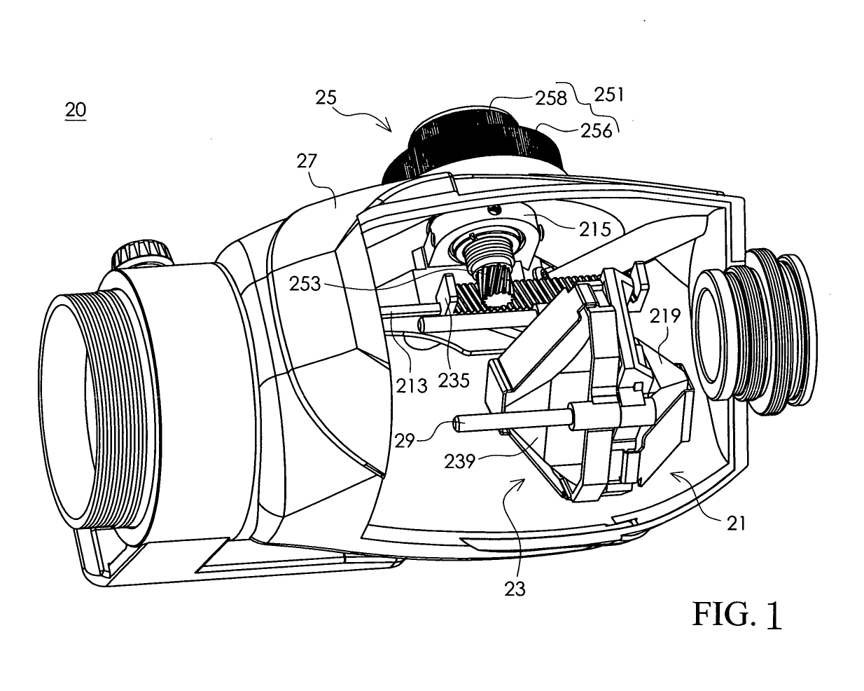

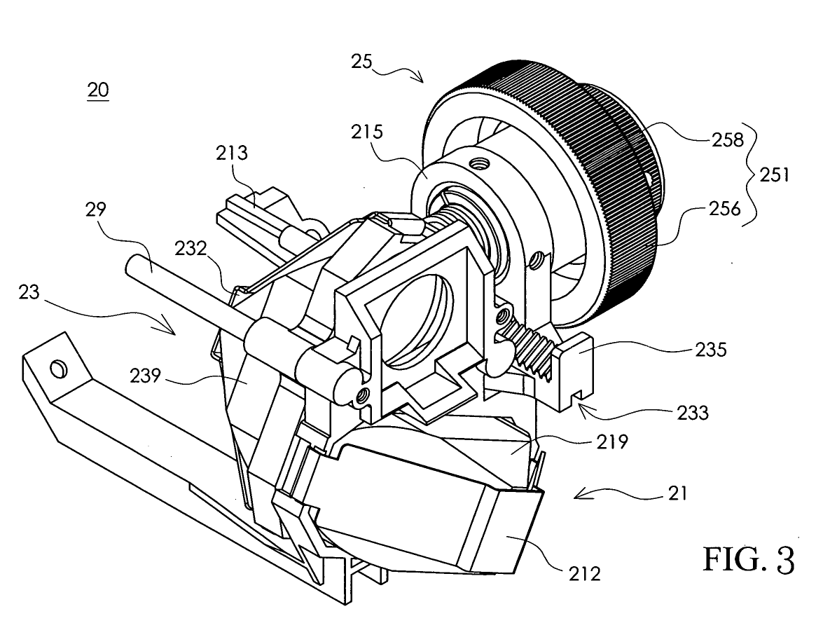

At first, referring to FIG. 1 to FIG. 3, a three-dimensional diagram, a structure decomposing diagram, and a structure assembly diagram of a preferred embodiment of the present invention are disclosed. The adjustment 20 comprises a base 21, an adjusting set 23, and an adjustor 25, and further, a shell body 27 can be selected to be used for covering the adjustment 20. The base 21 and the adjusting set 23 are provided fixedly within the shell body 27, wherein the base 21 comprises a first mirror 211 and a slide guide 213, wherein the adjusting set 23 comprises a second mirror 231, a guide groove 233, and a guide tooth space 235. The second mirror 231 is provided corresponding with the first mirror 211. The guide tooth space 235 and the guide grove 233 are provided back to back with each other, such that the guide groove 233 and the slide guide 213 can be assembled together, and further, the adjusting set 23 can be placed on the base 21 accordingly.

The adjustor 25 comprises an adjusting rotatable button 251 and a driving screw 253, both of which are positioned at the same axle 24. The driving screw 253 is with a screw thread 257 that can be assembled with a tooth space thread 237 of the guide tooth space 235. In this case, the screw thread 257 and the tooth space thread 237 are with the same pitches, such that the driving screw 253 can be used to drive the guide tooth space 235 by rotating the driving screw 253 due to the screw thread 257 and the tooth space thread 237 are assembled. The adjusting rotatable button 251 can be extended to the outside of the shell body 27, accordingly, when the adjusting rotatable button is rotated, the driving screw 253 will be drove and rotated, such that the guide tooth space 235 will be shifted transversely, and the second mirror 231 will be shifted corresponding with the first mirror 211 for improving the stability as adjusting focus.

The adjustor 25 is provided on the external side of shell body 27. The driving screw 253 and the guide tooth space 235 are placed at orthogonal attitude with each other. Therefore, the adjustor 25 can drive the guide tooth space 235, and further, the base 21 and the adjusting set 23 are going to shift accordingly. According to the movement of the adjustor 25, more convenient will be achieved, especially, as the adjustment is used for the ground-based observation telescope, the adjustor 25 is provided on the external side of the shell body 27, such that the adjusting focus and angle will be more convenient, furthermore, the adjustor 25 can be placed on the external right side or the external left side of the shell body 27 according to the observer's dominant hand. Thus, there are various choices for consumers according to their habits.

Regarding to another embodiment, the first mirror 211 comprises a first prism 219 and the second mirror 231 comprises a second prism 239, wherein both of the first prism 219 and the second prism 239 can be a Porro prism, therefore, a Porro prism set can be composed accordingly. The Porro prism set can be used to alter the lighting path come from the object lens, such that the eyepiece and the object lens of the telescope can be with different heights and angles, thus, the observer can take this advantage during a long-term observation. Otherwise, the distance between the second prism 239 and the first prism 219 can be adjusted for focusing, such that the observer can have more distinct sight.

The first mirror 211 further comprises a first wedge body 212 provided fixedly on the peripheral of the first prism 219. Due to the first wedge body 212 is fixed on the first mirror 211, the first prism 219 can be placed within the first mirror 211 stably. The second mirror 231 also comprises a second wedge body 232 provided fixedly on the peripheral of the second prism 239. As well as, Due to the second wedge body 232 is fixed on the second mirror 231, the second prism 239 can be placed within the second mirror 231 stably.

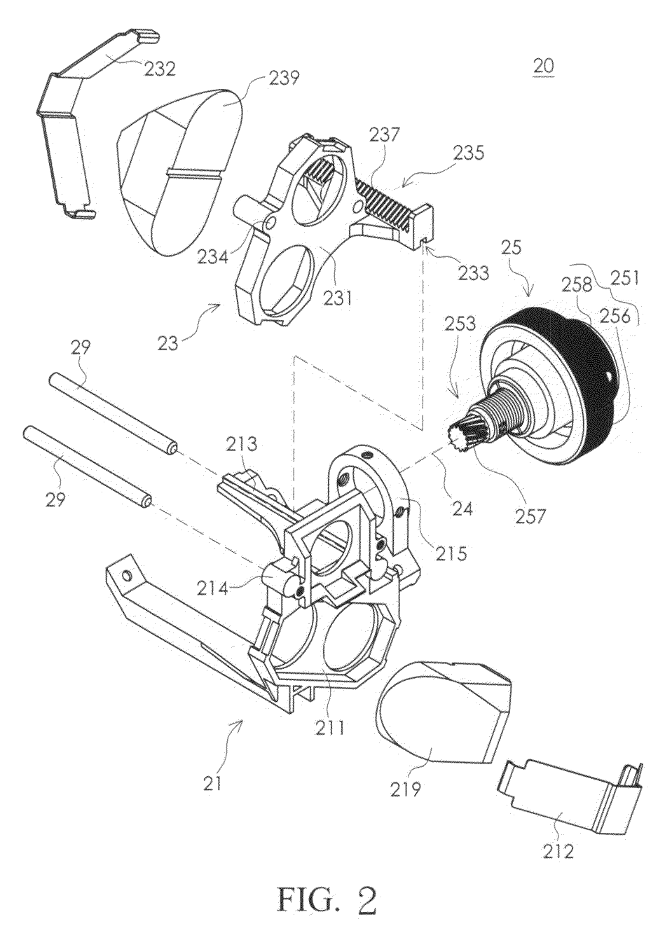

Furthermore, the first mirror 211 comprises at least one socket 214, the second mirror 231 comprises at least one transpierced hole 234, wherein the position of the transpierced hole 234 is provided corresponding with the socket 214, such that a slide bar 29 can be fixed on the socket 214 by passing through the transpierced hole 234. Due to the slide bar 29 is used to pass through the base 21 and the adjusting set 23, the slide bar 29 will be another support-end of the first mirror 211 and the second mirror 231 while the second mirror 231 is shifted corresponding the first mirror 211, such that the stability of the first mirror 211 and the second mirror 231 will be improved. As shown on FIG. 2, there two slide bars 29 and the corresponding transpierced holes and sockets 214. In fact, the number of the slide bars 29, the transpierced holes 234, and the sockets 214 can be altered according to the demand.

The adjusting rotatable button 251 can be selectively as one of sing-stage adjusting rotatable button and multi-stage adjusting rotatable button. Therefore, when the adjusting rotatable button 251 is selected to be a multi-stage rotatable button, a finer adjusting can be required for users, such that the accuracy of adjusting focus will be improved efficiently. For example, the adjusting rotatable button 251 comprises a coarser adjusting rotatable button 256 and a finer adjusting rotatable button 258 for being used to coarser adjust or finer adjust.

The base 21 further comprises a ring 215 provided on the same side with the adjustor 25, and further, the driving screw 253 is placed by passing through the ring 215, such that the stability of the adjustor 25 can be improved, accordingly, the adjustor 25 can be rotated without swaying.

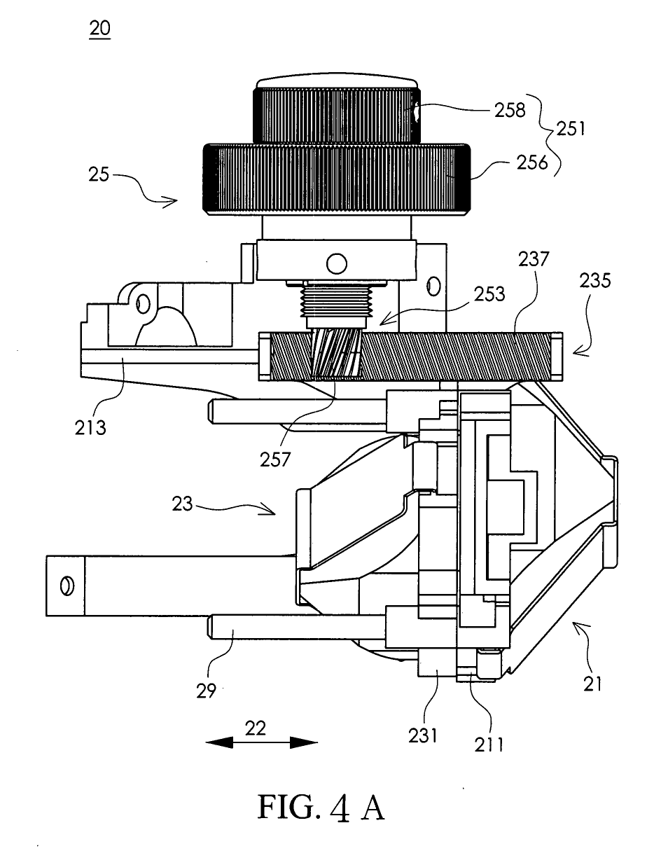

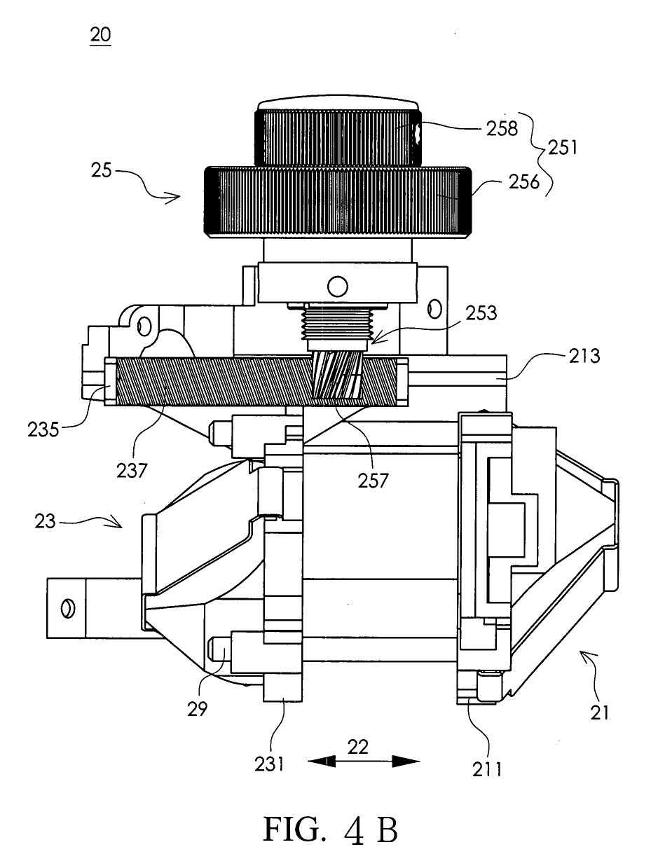

Referring to FIG. 4A to FIG. 4B, a diagram of a preferred embodiment of the present invention regarding to the action of the adjustment is disclosed. The guide groove 233 of the adjustor 23 and the slide guide 213 of the base 21 are assembled together, such that the base 21 and the adjustor 23 can be correspondingly shifted with each other along a first direction 22. Due to the screw thread 257 and the tooth space thread are toothed with each other, the adjustor 25 can drive the adjusting set 23 to move during the adjusting focus period, and further, when the adjusting set 23 has been positioned, the adjusting set 23 will not be slid accordingly.

The adjusting rotatable button 251 can be used to focus for having the distinct sight. In detail, as the adjusting rotatable button 251 is rotating to drive the driving screw 253, the guide tooth space 235 assembled with the driving screw 253 will be shifted on the guide bar 213 along the first direction 22. The distance between the adjusting set 23 and the base 21 will be altered during the rotating adjusting rotatable button period, and the distance between the first mirror 211 and the second mirror 231 will be altered accordingly, such that the optical path between the eyepiece and the object lens of the telescope can be altered for adjusting focus, accordingly, due to the slide bar 29 and the guide groove 233 are parallel with each other, the adjusting set 23 can be shifted stably.

The screw thread 257 and the tooth space thread 237 are formed as the inclined type, thus, these two threads can be toothed better for improving the stability of the adjustment 20 due to the swaying possibility between the tooth space thread 237 and the screw thread 257 is reduced. Certainly, the screw thread 257 and the tooth space thread 237 can be assembled by other types for driving with each other, such as the straight type and so on. Furthermore, the first mirror 211 and the second mirror 231 can have other types of optical glasses therein, such as the lens, reflector, and so on, for achieving various optical demands.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

I claim:

1. An adjustment used for the ground-based observation telescope, comprising:
a base comprising a first mirror and a slide guide;
an adjusting set comprising a second mirror, a guide groove, and a guide tooth space, wherein said guide groove and said slide guide are assembled together, wherein said guide tooth space and said guide tooth space are provided back to back with each other, wherein said second mirror is positioned corresponding with said first mirror; and
an adjustor comprising an adjusting rotatable button and a driving screw, both of which are positioned at the same axle, wherein said driving screw and said guide tooth space are assembled together, wherein said guide tooth space can be shifted since said adjusting rotatable button has been rotated, and said second mirror will be shifted corresponding said first mirror accordingly.

2. The adjustment of claim 1, further comprising a shell body used for covering said adjustment.

3. The adjustment of claim 2, wherein said adjustor is placed at the external side of said shell body, and said driving screw and said guide tooth space are placed at orthogonal attitude with each other.

4. The adjustment of claim 1, wherein said first mirror comprises at least one socket, said second mirror comprises at least one transpierced hole and at least one slide bar, wherein said slide bar is fixed on said socket by passing through said transpierced hole.

5. The adjustment of claim 1, wherein said adjusting rotatable button can be selectively as one of a single-stage adjusting rotatable button and multi-stage adjusting rotatable button.

6. The adjustment of claim 1, wherein said first mirror further comprises a first wedge body.

7. The adjustment of claim 1, wherein said second mirror further comprises a second wedge body.

8. The adjustment of claim 1, wherein a first prism is provided fixedly on said first mirror.

9. The adjustment of claim 8, wherein a second prism is provided fixedly on said second mirror.

10. The adjustment of claim 9, wherein said first prism and said second prism are the Porro prism respectively, such that can be assembled as a Porro prism set.

11. The adjustment of claim 1, wherein said base further comprises a ring.

12. The adjustment of claim 1, wherein said guide tooth space is with a tooth space thread, and said driving screw is with a screw thread.

13. The adjustment of claim 12, wherein said tooth space thread and said screw thread are with the same pitches.
